(19) United States
(12) Patent Application Publication
(10) Pub. No.: US 2015/0248684 A1
(43) Pub. Date: Sep. 3, 2015

(54) DATA COLLECTION AND PROACTIVE TASK DISTRIBUTION SYSTEM THROUGH CROWDSOURCING

(71) Applicant: William J. Szafranski, Titusville, NJ (US)

(72) Inventor: William J. Szafranski, Titusville, NJ (US)

(21) Appl. No.: 14/634,817

(22) Filed: Feb. 28, 2015

Related U.S. Application Data
(60) Provisional application No. 61/946,196, filed on Feb. 28, 2014.
(60) Provisional application No. 61/971,723, filed on Mar. 28, 2014.

(51) Int. Cl. G06Q 30/02; H04W 4/02

(52) U.S. Cl. CPC G06Q 30/0205; H04W 4/021

(57) ABSTRACT

A method and system is provided that ensures the request for information or task is provided or sent to the member or members of the crowd best suited to obtain or collect the requested information or task. The method and system further ensures the accuracy of the collected information or task by ensuring that the specific member or members of the crowd collecting the information or performing the task is actually in a location that contains the information. The method also ensures that the crowd members responding to the requests meet other criteria determined necessary for the collection of the data/information needed to further ensure accuracy of the collected information or performance of the task.

### 1.0 BACKGROUND OF THE INVENTION

1.1 Field of the Invention

The present invention relates to crowdsourcing. More particularly, the invention relates to methods and system for collecting data from specific locations through crowdsourcing.

1.2 Description of Related Art

Crowdsourcing is the practice of accomplishing a task or project by enlisting the work of a large pool of people, typically utilizing the internet to maintain the workflow process. There are several types of crowdsourcing. One type of crowdsourcing is referred to as crowd labor where a large pool of people is enlisted to perform specific tasks to achieve a desired result for a product, database, or other purpose.

Information obtained by current methods of crowdsourcing has a number of inherent deficiencies. Primary among these deficiencies is that crowdsourcing has been a reactive process. Current methods rely on members of the crowd to specifically seek out work, projects, tasks, etc. Requesters post this work, i.e., tasks to obtain (collectively a “request”) data and/or information to a platform. Contributors from the crowd that interact with the platform choose the work or tasks they would be interested in completing. Typically members review a particular request or task and then set about obtaining the data or completing the task. The current reactive system puts the requester in a difficult position as they are not always sure they have the best people suited for particular tasks assigned to working on those tasks. While there are systems in place to assist the reactive crowdsourcing model, the model still lacks important qualities to achieve maximum benefit for the requester. This presents the opportunity for contributors in the crowd to provide inaccurate data either because they are not properly qualified, not in the proper location, cannot find the appropriate source, or alternatively, make up the data or obtain it from an alternate source.

More specifically, a particular request may be better suited to a particular member of the crowd based on certain parameters, requirements, or qualifications relevant to the request. However, current reactive crowdsourcing techniques have limited ways to control which member of the crowd working on that platform can choose to respond to the request. Accordingly, efficiency suffers for both the members of the crowd who spend time answering a request they are unsuited for, and for the requester who has to try and determine which data is reliable and which is not.

Accordingly, there is a need for gathering information from members of a crowd that permits the requester to direct the requests for information specifically to the members of the crowd that are best suited to obtain the information.

There is a need for obtaining information from a crowd that is sent to members of the crowd when they are in actually in the location that contains the information desired.

### 2.0 SUMMARY OF THE INVENTION

The present invention addresses the problems of prior art crowdsourcing processes by providing a method and system that ensures the request for information or task is provided or sent to the member or members of the crowd best suited to obtain or collect the requested information or task. The current invention further ensures the accuracy of the collected information or task by ensuring that the specific member or members of the crowd collecting the information or performing the task is actually in a location that contains the information. Further the method of the current invention may also ensure that the crowd members responding to the requests meet other criteria determined necessary for the collection of the data/information needed to further ensure accuracy of the collected information or performance of the task.

In one embodiment, a method and system of proactively pushing work to the crowd based on certain criteria is provided. The method and system allows the requester (the person or persons that desire the information or task) to choose which members of the crowd will be permitted to answer specific requests from the project database. In this way, the requester controls who answer a particular request instead of sending the request to the entire crowd and allowing crowd members to choose individually. By proactively pushing work (tasks or request for information) to the crowd based on the requester's needs and members of the crowd's availability, the requester can more efficiently solve its needs. The criteria used to determine to which crowd member to push work is critical in matching the needs of the product (database) the requester is working on to the criteria of a particular member of the crowd. The criteria could include but is not limited to location, demographics, date/time, historical data collect quality, and historical data collect production.

### 3.0 BRIEF DESCRIPTION OF THE DRAWINGS

The following figures are for illustrative purposes only and are not intended to limit the scope of the present invention in any way:

FIG. 1 illustrates a system for crowdsourcing information from members of a crowd set up in accordance with the present invention.

FIG. 2 illustrates a flow chart of a method of obtaining data from individual members of the crowd based on the location of the member and/or additional criteria.

FIG. 3-5 illustrates one potential application of a user interface utilized by a member of the crowd.

### 4.0 DETAILED DESCRIPTION OF THE PREFERRED EMBODIMENTS

### 4.1 Definitions

The terms used herein have the following meaning unless otherwise indicated:

“Server” means a computer system in a network that is shared by multiple users. “Server” may refer to both the hardware and software (the entire computer system) or just the software that performs the service.

“Database” means a database which is basically a collection of information organized in such a way that a computer program can enter, remove, organize and select desired pieces of data. Use of the term “database” in this application includes the hardware, software, programs or system that allows the entry, removal or organization of the data.

“Mobile device” means a device that is carried or worn by an individual and can communicate wirelessly over the internet such as, for example, a smart phone, tablet, laptop, smart glasses, or other wearable technology. Typically the “mobile device” is a small, handheld or other wearable technology computing device typically having a display screen with touch input and/or a miniature keyboard.

“Geo-location” means the identification of the real-world geographic location of an object (such as a mobile device).

“Information” or “data” are used interchangeably and mean the answer or subject of a request to a member.

### 4.2 Embodiments

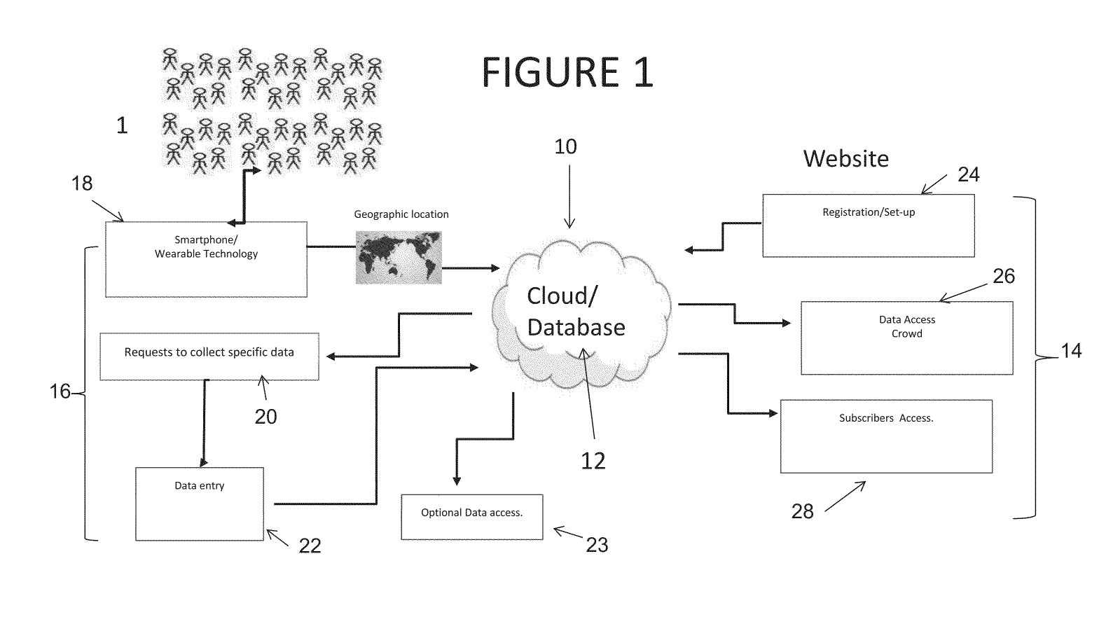

FIG. 1 illustrates one method and system in accordance with the invention. The method and system provides for the collection of data from a crowd 1 and optionally the distribution of the data to a crowd 1. The system includes a server 10, preferably a cloud based server 10, that hosts a database 12 and preferably a 14 website. The database 12 and website 14 communicate with the crowd 1 and functions to store data and send requests for information to the crowd 1 based on certain criteria being met. The communication between the crowd 1 and the server 10 is represented generally on the left side of FIG. 1 at 16 and communication between the website 14 and the server 10 is illustrated on the right side of FIG. 1 at 14. The crowd 1 is composed of one or more members (individuals) that communicate with the server/database 10/12, preferably by way of an application (“App”) that is installed on a mobile device 18.

The members of the crowd 1 carry around the mobile device 18, such as a smartphone (smartphone and mobile device used interchangeably throughout), as they would in the normal course of their day. The mobile device 18 is installed with an application (“App”) that allows the device to communicate wirelessly with the server 10. Each mobile device 18 has geo-location capabilities so that the location of the mobile device 18, and thereby the member, is tracked as they move. The means for tracking the geo-location of the mobile device is preferable with a GPS system already installed on a mobile device 18 but other means may be used. The mobile device 18 App is setup by each contributing member of the crowd 1 and would preferably include a registration process for each member of the crowd 1 providing each member of the crowd with a unique identifier, such as a user ID. Registration also includes activation of a geo locator on each mobile device 18 to track the location of the mobile device 18 (and therefore the location of registered member of the crowd 1).

The geographic location of each member of the crowd is monitored, stored and used when determining how and when to push work (Requests 20 discussed in more detail below) to particular member of the crowd. The geo locator must be turned on for a Request 20 to be received by a particular member of the crowd 1.

In operation, the server 10 continuously monitors the location of the individual mobile devices 18, typically in terms of latitude and longitude. The database 12 preferably stores information about each member. For example, for each member the database 12 may store information such as a user ID, username, and encrypted password. The database 12 may store additional information about the member as described in more detail below. Based on the location of the mobile device 18, and optionally one or more of the additional pieces of information associated with the member, the server 10 sends a Request 20 for information to the member. The Request 20 for information is predetermined and associated with a specific location.

Based on contributor data (data or information about the particular registered crowd member), which includes geographic location supplied by the geo locator and database needs, Requests 20 to collect specific data is pushed, i.e. sent, to each member's mobile device 18.

The Request 20 for information can be for any type of information needed in the database 12 and that can be found by a member in a particular location. The same Request 20 can be associated with multiple locations. Similarly, a single location can be associated with multiple Requests 20. One example of such a Request 20 would be a request to a crowd 1 member for a price of a particular product. This type of Request 20 would be associated, for example, with a location of store likely to carry such product. Other examples of information that would be the subject of a Request 20 include, but are not limited to price confirmation, marketing compliance, product availability and consumer sentiment.

As the server 10 is continuously monitoring the location of the mobile device 18, it will recognize when the mobile device 18 is in a location that is associated with a Request 20. The server 10 automatically sends the Request 20 to the mobile device 18 and is received by the member. The member then collects the requested information. The collected information is referred to as data 22. The data 22 can be collected by the member through a variety of means; for example, the information can be collected by scanning bar codes, hand entered, taking a picture or other method for capturing an image, writing free text, and other means. Once the data 22 is collected, it is sent to the server 10 by the member. The server 10 then preferably stores the data 22 in a database 12 in such a way that both the mobile device 18 application and website 14, and optionally members, could access 23 the data stored on the server 10 directly.

Preferably, the decision to send a Request 20 to a particular member in a particular location is based on one or more additional criteria. The types of criteria can be of any kind that would, in theory, increase the likelihood of getting accurate data. In operation, a particular request may be associated with a particular characteristic or set of characteristics, such as demographic information (gender, age, etc.). For example, a Request 20 for price information on a particular type of women's clothing could be targeted to women of a certain age range. When a member that is a woman in that age range enters one of the locations associated with that Request 20, the Request 20 is sent to that member. If however, another, member enters that same location but is not a woman in that age range, the Request 20 is not sent. Note however, that other Requests 20 may still be associated with that location.

The additional criteria need not be limited to demographic information. Examples of additional criteria include collection history, purchasing history, or other information. This information would typically be known and entered via the application on the mobile device 18. In one embodiment, member information can be entered into a website 14 in communication with the server 10. Those skilled in the art will be able to configure various methods of associating a particular member with a set of criteria. While many configurations are possible, the configuration will include a method where specific Requests 20 are sent, or pushed, to members of the crowd 1 in a position to collect the data accurately.

In the preferred embodiment, the collected data 22 can only be sent back to the requesting server if the mobile device 18 is within a certain range of the particular location associated with that request. This feature ensures that the mobile devices 18, and the members, are in the appropriate location to collect the requested data 22.

The additional criteria associated with each member can be obtained a variety of ways, including but not limited to, through the application installed on the mobile device 18, or through a website 14. In one embodiment, the member answers a series of questions to elicit the required information. The questions are answered by the member when registering to be a member. In the preferred embodiment, the application cannot be activated until the questions are answered. In addition, questions may also be asked to the crowd before or during the process of working on or completing a task.

As illustrated in FIG. 1, preferably, a website 14 is in communication with database 12 through the server 10. Individual members of the crowd 1 can interface with the database 12 through the website 14. The website 14 preferably provides and receives the same or similar types of data as the App installed on the mobile devices 18. Preferably the website 14 performs a variety of functions. For one example, the website 14 allows prospective members of the crowd to register 24 and provide full details of how the crowdsourcing method operates. In one embodiment, the website 14 optionally provides crowd member access 26 to some or all of the data entered by the crowd 22. Crowd member access 26 may be granted to crowd 1 member without limitation or alternatively based on a variety of conditions being met, such as frequency of submissions of data 22. Other optional functionality of the website includes, but is not limited to giving the ability to see submissions by individual member of the crowd 1; providing the ability to post comments/reviews of products and stores; and providing the ability to communicate directly or indirectly with other members of the crowd 1.

In one embodiment, the website allows member to have the same functionality as the mobile device 18 application except the ability to submit prices which is regulated by geo location.

The website 14, optionally and preferably provides subscribers access 28 to the data 22 collected by the crowd 1 members. Subscribers (or customers) are typically non-crowd 1 members that want access to, and preferably pay for, some or all of the data 22 collected by the crowd 1 members. The website 14 is only one way subscribers or customers may have access to the data. In another embodiment subscribers or customers have access to the data via an Application Program Interface (“API”). The API allows for direct access to the database 12, as an example of an alternate method of subscriber access 28. In another embodiment, subscribers or customers can make requests for specific types of data or for data obtained with specific types of criteria through the website or other means. For example, subscribers may be individual companies or trade association that may be interested in collecting data on the status of their business from independent parties, the status of other companies, the status of specific products, general economic information or indicators of activity for specific industries, etc.

As discussed above, the server 10 performs a number of different functions. “A server” can actually be multiple servers (or a cloud) performing the same functions or each server with a dedicated function. Collectively, the servers (or a cloud) host the databases that perform the necessary functions of the system such as communicating with the mobile devices 18 and storing the data 22 collected. In one embodiment all data 22 would be stored in a database 12 in such a way that the mobile device 18 application, the website 14, and potentially clients could access the data 22 directly. In addition to storing all of the data 22 collected by the crowd 1 (members), there is a database 12 of one or more of the following categories of information: target locations (i.e. retail stores) and their associated geographic coordinates; products and bar codes if applicable; time stamp of collection; demographic information of each contributor; and individual data collection history of each contributor. All of this information would drive the decisions for proactive data collection (sending Requests 20), and determine the standing of each contributor (crowd member), which could determine their access to retrieving data 23 or their standing to receive Requests 20.

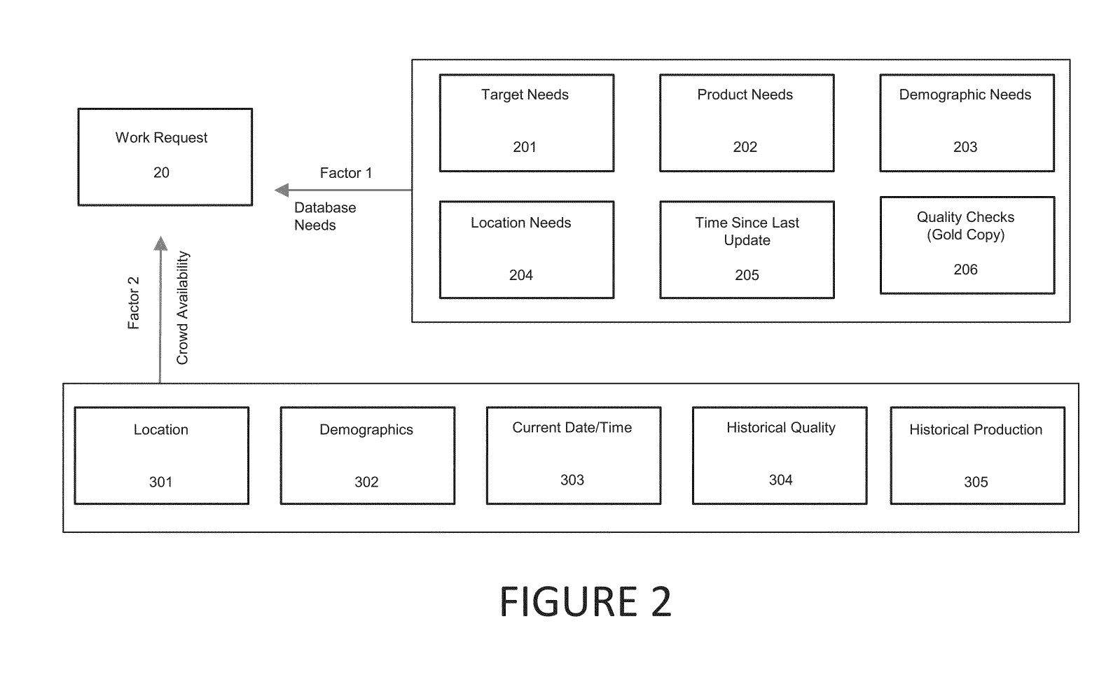

FIG. 2 illustrates a flow chart of one example of a method of deciding which crowd 1 member to proactively push work (sending Requests 20) to based on certain criteria. In FIG. 2, box 20 represents the Request. As described above, the Request 20 is a request or instruction for a task to be performed or information and data to be collected. In the embodiment of FIG. 2, the decision to send the each specific Request 20 is determined by two drivers or factors, Factor 1 and Factor 2. Unless both factors are met by a single member of the crowd 1 at any given time, the Request is not sent. In FIG. 2, Factor 1 is the Database Needs and Factor 2 is the current Crowd Availability. Other Factors may be used and the embodiment of FIG. 2 represents only one possible method of deciding to which member of the crowd 1 a Request 20 should be sent.

Factor 1, Database Needs, is comprised of a number of subcategories. In the embodiment shown, a number of different subcategories are considered in determining the Database Needs. However, the number and type of subcategories will vary according to the requirements of the requestor of the data. In this embodiment, the following Database needs are included, although not all subcategories are necessarily used for each Request 20 and other subcategories not listed may be used:

201 is Target Needs—The database 12 determines which target (i.e., retail store) currently has a deficiency in data

202 Product Needs—The database 12 determines the products or items in a target that need new or updated information

203 Demographic Needs—The database 12 determines if there is a specific demographic under-represented in collecting data 22 (if applicable)

204 Location Needs—The database 12 determines deficiencies in data 22 collected from specific target locations based on the geo-coordinates

205 Time Since Last update—The database 12 determines how frequently data 22 has been updated in the past and when was the last time data was updated to find updates needed because the data is stale

206 Quality Checks—The database 12 verifies data 22 based on consensus crowd collection to determine correct values. The database 12 will the send a Request 20 on some percentage of those items to test the collection of new or existing crowd 1 contributors.

Factor 2, Crowd Availability, similar to Factor 1 is comprised of a number of subcategories. FIG. 2 shows a number of different subcategories, however, the number and type of subcategories will vary according to the requirements of the requestor of the information. In this example, the following Crowd Availability subcategories are included although not all subcategories are necessarily used for each Request 20 and other subcategories not listed may be used:

301 Location—Utilizing geo-location features on a mobile device 18 allows the mobile device 18 application to determine if a contributor(s) matches a Location Need as determined by the database 12.

302 Demographics—Based on the demographics entered by each individual crowd 1 member, the mobile device 18 application, database or website determines if there is a crowd 1 member or members that match a Demographic Need determined by the database 12.

303 Time—The application will note the date/time of the mobile device 18 being used by a crowd 1 member or members to determine if there is a member or members that matches the Time Since Last Update Need determined by the database 12.

304 Historical Quality—The mobile device 18 application, database or website factors in the historical work (data provided in response to a Request 20) provided by each crowd 1 member to determine a quality score as compared to the crowd 1. Based on this quality score, the crowd 1 member would be requested to do certain levels of Requests 20. For example, a higher quality score would result in a more complex Request 20

305 Historical Production—The mobile device 18 application, database or website factors in the historical work provided by each crowd 1 member to determine a production score. This score would determine the amount of Requests 20 sent to each of the contributors. For example, a higher production score would result in more Requests to the member of the crowd while a lower score would result in fewer Requests being sent.

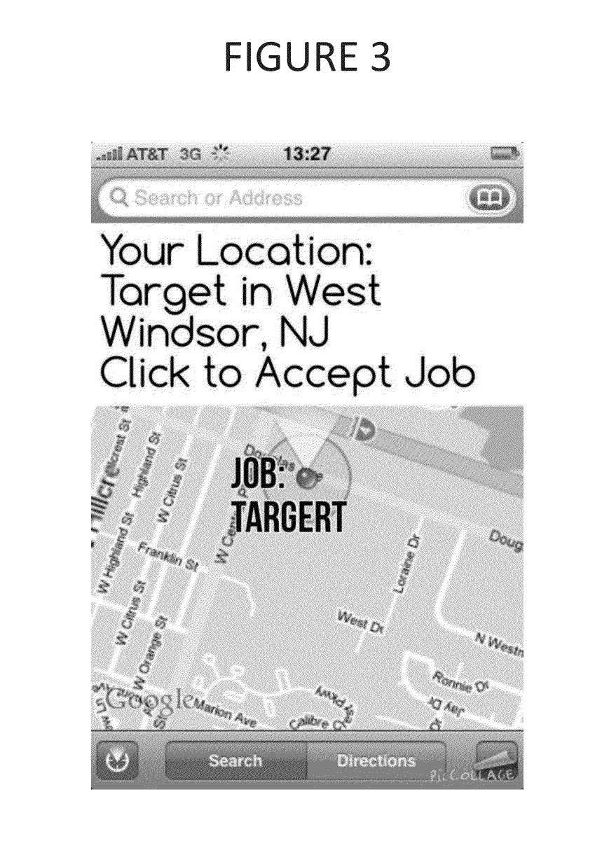

FIGS. 3-5 show some sample screen shots of an embodiment of the invention shown from the perspective of a crowd member carrying a registered mobile device. FIG. 3 shows the mobile device's 18 geo-location. The server 10 (not shown) tracks the geo-location and its proximity to a location associated to a Request. The screen in FIG. 3 shows that the mobile device is located at a location (a retail store in a particular town) associated with a Request. The database 12 (not shown) decides what data, if any, is required from the location and what data the particular crowd member is suited to obtain (according, for example, to the predetermined factors).

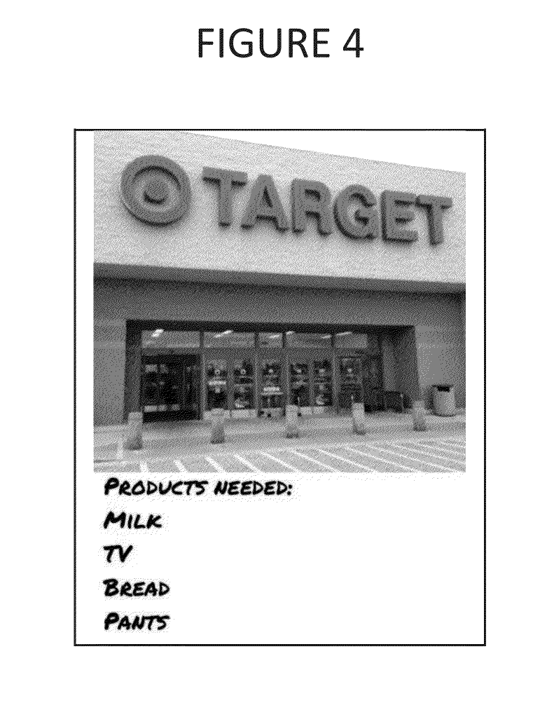

FIG. 4 shows a sample of a Request sent to a crowd member. The App may show a picture of the actual store front or just a generic picture of the store by type or of the specific chain. The crowd member has access to this type of screen only after the database determines the crowd member should receive the Request. The Request identifies products for which information is needed to be obtained by the crowd member at the location. More or less information could be presented in a Request such as a request for price, brand name, amount available and many other product characteristics. The Request can also contain multiple screens presenting a series of Requests. In this embodiment, the crowd member first selects a specific product to proceed with.

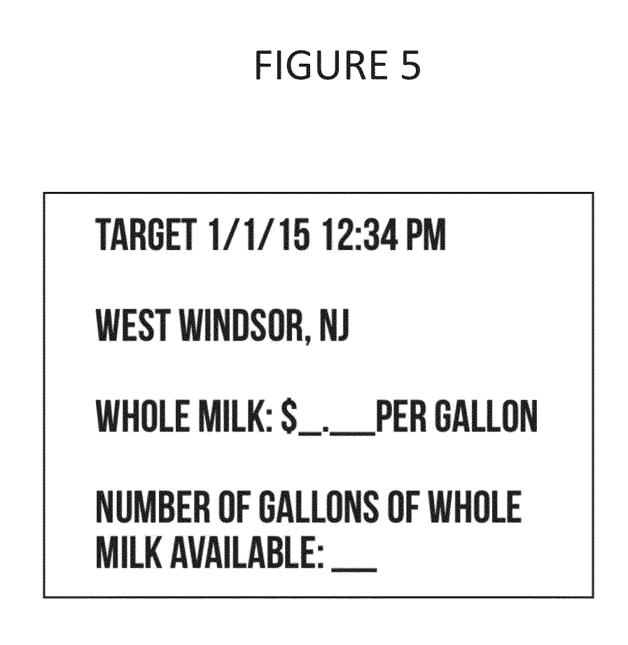

FIG. 5 show a sample the Request once the crowd member has selects a product, in this instance, milk. This page of the Requests provides the crowd member with specific data need to be obtained (data) and sent back to the server.

These screen shots only show one example of the type of request and the format for the Request. Those skilled in the art will readily recognize that Requests can be sent and data returned in a variety of formats.

### 5.3 Alternatives

There will be various modifications, adjustments, and applications of the disclosed invention that will be apparent to those of skill in the art, and the present application is intended to cover such embodiments. Accordingly, while the present invention has been described in the context of certain preferred embodiments, it is intended that the full scope of the invention be measured by reference to the scope of the following claims.

What is claimed is:

1. A method of collecting data from members of a crowd, wherein the members of a crowd each have a mobile device, the method comprising:
tracking the location of the mobile devices of the members of the crowd;
determining if one or more mobile devices are within one or more predetermined locations
sending a request to the one or more mobile devices for the collection of specified data when the one or more mobile devices are within the predetermined locations;
wherein each predetermined location has one or more predetermined requests associated with the location.

2. The method of claim 1 further comprising the steps of:
entering the data into the mobile device; and
transmitting the entered data from the mobile device to at least one remotely located database.

3. The method of claim 2 wherein the data is transmitted from the mobile device only if the mobile device is with a specified range of the location that is associated with the specific request.

4. The method of claim 1 wherein the request is sent based on one or more additional criteria being met.

5. The method of claim 4 where the additional criteria comprise the demographic information of the member.

6. The method of claim 2 wherein the data is entered into the mobile device by bar code Scanning.

7. The method of claim 2 wherein-the data is entered into the mobile device by taking a picture or other method of image capture.

8. The method of claim 1 wherein the specified data comprises pricing information on a product or service.

9. The method of claim 5 wherein each member's mobile device is associated with the demographic information of the member.

10. A system for collecting data from a crowd, wherein the members of the crowd each have a mobile device, the system comprising:
a database containing one or more predetermined requests for information associated with one or more geographical locations,
a means for tracking the geographical location of each of the mobile devices; and
a means for sending the request for information to the mobile devices when one or more of the mobile devices is within a specified range of one of the geographical locations.
